(19) United States
(12) Patent Application Publication
(10) Pub. No.: US 2021/0014198 A1
(43) Pub. Date: Jan. 14, 2021

(54) NETWORK SECURITY SYSTEM AND METHOD WITH MULTILAYER FILTERING

(71) Applicant: Saudi Arabian Oil Company, Dhahran (SA)

(72) Inventors: Mohammed Mohsen Amoudi, Dhahran (SA); Amani Mohammed Kamal Rafie, Dhahran (SA); Hani Saeed Masmoom, Dhahran (SA)

(21) Appl. No.: 16/505,915

(22) Filed: Jul. 9, 2019

(51) Int. Cl. H04L 29/06; H04L 12/58; H04L 29/08; H04L 29/12

(52) U.S. Cl. CPC H04L 63/0236; H04L 63/20; H04L 63/0209; H04L 12/66; H04L 51/22; H04L 67/10; H04L 61/2007; H04L 63/0245

(57) ABSTRACT

A solution for analyzing and filtering an email message destined to a computing resource in a computer network that has been security processed by a cloud-based email security system. The solution includes establishing a communication link with the cloud-based email security system, receiving an email message by an on-premises email security (OPES) system hosted in a demilitarized zone in the computer network, determining whether the received email message is sent from an authorized node in the cloud-based email security system, forwarding the received email message to an on-premises email security gateway located in the demilitarized zone, analyzing the forwarded email message, and sending the forwarded email message to a mail server in the computer network.

### TECHNOLOGICAL FIELD OF THE DISCLOSURE

The present disclosure relates to a network security solution that includes a method, a system, and a computer program for multilayer analysis, filtering or remediation of email traffic directed to a computing resources in a computer network.

### SUMMARY OF THE DISCLOSURE

According to a non-limiting embodiment of the disclosure, a method is provided for analyzing and filtering an email message destined to a computing resource in a computer network that has been security processed by a cloud-based email security system. The method comprises: establishing a communication link with the cloud-based email security system that applies a cloud-based email security policy to analyze and filter all email traffic destined to the computer network; receiving an email message by an on-premises email security (OPES) system hosted in a demilitarized zone in the computer network; determining whether the received email message is sent from an authorized node in the cloud-based email security system; forwarding the received email message to an on-premises email security gateway located in the demilitarized zone based on whether the email message was sent from the authorized node in the cloud-based email security system; analyzing the forwarded email message by the on-premises email security gateway based on an on-premises email security policy; and sending, by the on-premises email security gateway, the forwarded email message to a mail server in the computer network, wherein the mail server receives as incoming email traffic only email messages received from the authorized node in the cloud-based email security system. The method can further comprise determining whether the received email message includes an authorized port number. The authorized port number can include port 25.

Determining the authorized node can comprise identifying an intermediary source IP address and comparing the intermediary source IP address against a table of authorized IP addresses.

Determining the authorized node can further comprise identifying a port number in the email message and comparing the port number against an authorized port number.

The cloud-based email security policy can include policy parameters that differ from policy parameters in the on-premises email security policy.

The on-premises email security policy can comprise a policy parameter that causes the on-premises email security gateway to analyze the email message using spam detection, sender reputation, email filtering, content analysis, or advanced malware protection.

The on-premises email security policy can comprise a policy parameter that causes the on-premises email security gateway to analyze an outgoing email message using data leakage prevention (DLP), a whitelist of files, a blacklist of files, a whitelist of recipients, or a blacklist of recipients.

The received email message can include an IP address of a node located in the computer network.

The received email message can include an IP address of a node located outside of the computer network and outside of the cloud-based email security system.

The method can further comprise: determining whether the received email message is sent from the mail server located in the computer network; analyzing the email message according to the on-premises email security policy; and forwarding the email message to a cloud-based email security gateway.

According to another non-limiting embodiment of the disclosure, a network security system is provided that has a cloud-based email security system that analyzes and filters all email traffic destined to a computer network according to a cloud-based email security policy. The network security system comprises: an on-premises email security gateway that receives incoming email traffic solely from a cloud-based email security gateway located in the cloud-based email security system, analyzes and filters the received email traffic according to an on-premises email security policy, and forwards any email attachments; a sandbox security system that receives the email attachments and analyzes the attachments to detect malware; and a mail server that receives filtered email traffic from the on-premises email security gateway, wherein the filtered email traffic consists only of email messages received from an authorized node in the cloud-based email security system.

The network security system can further comprise an Internet facing firewall that filters all email traffic to the computer network, wherein the firewall is configured to allow only incoming email traffic from the authorized node to pass through to the on-premises email security gateway.

According to another non-limiting embodiment of the disclosure, a non-transitory computer readable storage medium is provided for storing computer program instructions that cause an email message from a cloud-based email security system that analyzes and filters all email traffic destined to a computer network according to a cloud-based email security policy to be analyzed and filtered, when executed by one or more computers. The computer executable program instructions comprising the steps of: establishing a communication link with the cloud-based email security system which uses first analysis and filtering policy parameters; receiving an email message by an on-premises email security (OPES) system hosted in a demilitarized zone in the computer network; determining whether the received email message is sent from an authorized node in the cloud-based email security system; forwarding the received email message to an on-premises email security gateway located in the demilitarized zone based on whether the email message was sent from the authorized node in the cloud-based email security system; analyzing the forwarded email message by the on-premises email security gateway based on second analysis and filtering policy parameters; and sending, by the on-premises email security gateway, the forwarded email message to a mail server in the computer network, wherein the mail server receives as incoming email traffic only email messages received from the authorized node in the cloud-based email security system.

The program instructions can comprise the further step of determining whether the received email message includes an authorized port number.

The authorized port number can include port 25.

The program instructions can comprise the further steps of identifying an intermediary source IP address and comparing the intermediary source IP address against a table of authorized IP addresses.

The program instructions can comprise the further steps of identifying a port number in the email message and comparing the port number against an authorized port number.

The program instructions can comprise the further step of applying a policy parameter that causes the on-premises email security gateway to: analyze the email message using spam detection, sender reputation, email filtering, content analysis, or advanced malware protection; or analyze an outgoing email message using data leakage prevention (DLP), a whitelist of files, a blacklist of files, a whitelist of recipients, or a blacklist of recipients.

Additional features, advantages, and embodiments of the disclosure may be set forth or apparent from consideration of the detailed description and drawings. Moreover, it is to be understood that the foregoing summary of the disclosure and the following detailed description and drawings provide non-limiting examples that are intended to provide further explanation without limiting the scope of the disclosure as claimed.

### BRIEF DESCRIPTION OF THE DRAWINGS

The accompanying drawings, which are included to provide a further understanding of the disclosure, are incorporated in and constitute a part of this specification, illustrate embodiments of the disclosure and together with the detailed description serve to explain the principles of the disclosure. No attempt is made to show structural details of the disclosure in more detail than may be necessary for a fundamental understanding of the disclosure and the various ways in which it may be practiced.

FIG. 1 shows an embodiment of a network security solution that includes an on-premises email security system constructed according to the principles of the disclosure.

FIG. 2 shows an example of an implementation of the on-premises email security system in a computer network.

FIG. 3 shows the seven-layer Open Systems Interconnection (OSI) model implemented in the disclosure.

FIG. 4 shows an architecture of a non-limiting embodiment of an on-premises email security controller that can be included in the on-premises email security system.

FIG. 5 shows an email security configuration process according to the principles of the disclosure.

FIGS. 6A and 6B show an on-premises email security process according to the principles of the disclosure.

The present disclosure is further described in the detailed description that follows.

### DETAILED DESCRIPTION OF THE DISCLOSURE

The disclosure and its various features and advantageous details are explained more fully with reference to the non-limiting embodiments and examples that are described or illustrated in the accompanying drawings and detailed in the following description. It should be noted that features illustrated in the drawings are not necessarily drawn to scale, and features of one embodiment may be employed with other embodiments as those skilled in the art would recognize, even if not explicitly stated. Descriptions of well-known components and processing techniques may be omitted so as to not unnecessarily obscure the embodiments of the disclosure. The examples are intended merely to facilitate an understanding of ways in which the disclosure may be practiced and to further enable those skilled in the art to practice the embodiments of the disclosure. Accordingly, the examples and embodiments should not be construed as limiting the scope of the disclosure. Moreover, it is noted that like reference numerals represent similar parts throughout the several views of the drawings.

Computer networks are continuously exposed to cyberattack threats, many of which can be catastrophic to a computer network or the entity that owns, controls or has valuable assets in the network, if successfully exploited. Most cyberattacks focus on web, email or file exchange communication channels, with many of the attacks successfully exploiting email communication channels in computer networks. Most of these threats target vulnerabilities in email infrastructure and application delivery portals in a computer network. Therefore, any comprehensive network security solution must include an effective email security solution that addresses risks related to email systems and the communication channels that lead into email systems in a computer network. The network security solution needs a system or a methodology that can continuously monitor, detect, assess and resolve risks associated with email communications in a computer network, and the computer network infrastructure that handles those communications. Moreover, with evolving and more advanced targeted cyberattack threats, many computer networks have responded to the risks by developing complex infrastructures that are costly to maintain and manage. A great need exists for a network security solution that can effectively prevent such cyberattack threats in a cost-efficient and -effective manner, while being able to adapt to the evolving and advancing cyberthreat landscape.

The instant disclosure provides a network security solution that satisfies the great need. The disclosure provides a network security solution that can include a hybrid cloud email security solution. The network security solution can include a composition of two or more computer clouds, such as, for example, a private network, a community network, or a public network, that can be operated or owned by distinct entities, or that can service distinct entities. The network security solution includes multilayer email analysis, filtering and security risk remediation, including an on-premises email security (OPES) system that can include a boarder security patrol (BSP) system located at the perimeter of the computer network. The OPES system can include an Internet email security gateway and a sandbox solution to analyze and filter email communications received from a cloud-based email security (CBES) system. The OPES system can perform a variety of security checks and filtering methodologies, including, for example, packet-header analysis, uniform resource locator (URL) analysis, payload analysis, content analysis, sender reputation analysis, network analysis, transmission path analysis, file attachment scanning, advanced email filtering, spam email detection, and other malware analysis and filtering to identify and remediate any potential risks identified during scanning of the emails received from the CBES system. The OPES system can parse and separate email attachments from email communications and analyze the email attachments using the sandbox solution to carry out malware analysis and remediation.

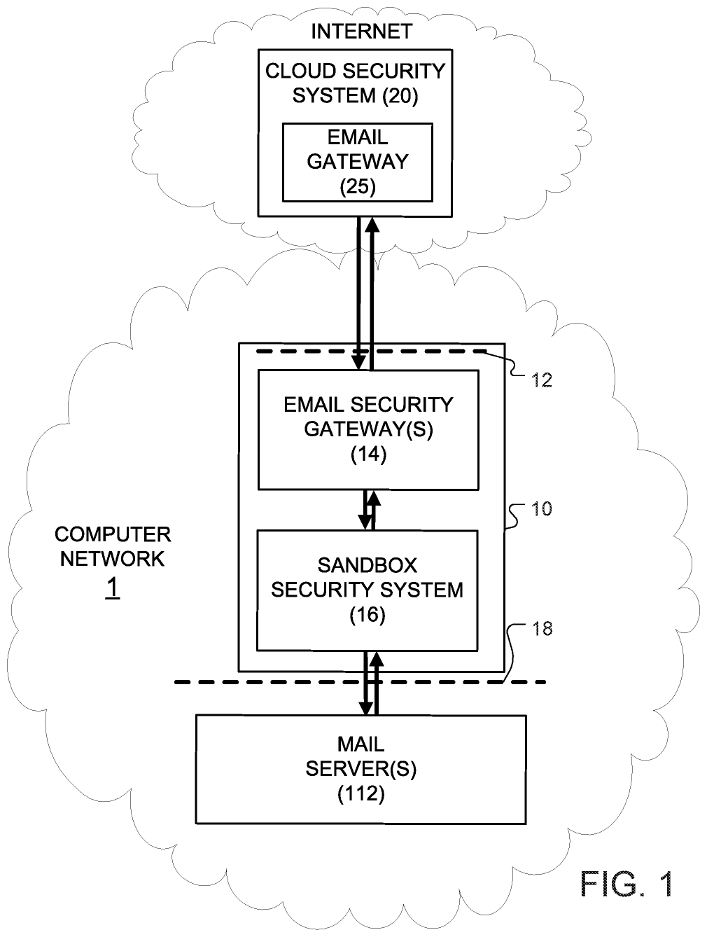

FIG. 1 shows an example of a network security solution (or system) that is constructed according to the principles of the disclosure. The network security system includes an on-premises email security (OPES) system 10 and a methodology that can substantially and effectively remove risks relating to cyberattacks that might attempt to exploit email communication channels or infrastructure in a computer network 1. The network security system can include a cloud-based email security (CBES) system 20, which can be combined with the OPES system 10 in the network security system to provide a multilayer, hybrid email security solution.

The CBES system 20 can receive, analyze and filter email traffic from any external source that is destined to the computer network 1. The CBES system 20 can also receive all email traffic outgoing from the computer network 1 and transmit the email traffic to destination nodes outside of the computer network 1. The analysis and filtering can be carried out in the cloud by the CBES system 20, before the email traffic is permitted to enter the computer network 1 via, for example, an email security gateway 25 in the CBES system 20. The CBES system 20 can receive all email traffic destined for the computer network 1 and scan, analyze and filter the received email traffic to remove spam, viruses, phishing emails, and other malware or unwanted emails before the resultant filtered email communications can reach the OPES system 10. The CBES system 20 can include, for example, packet header analysis, URL analysis, content analysis, payload analysis, reputation analysis, malware filters, spyware filters, spam filters, and content filters, to scan, analyze and remediate all email traffic destined to the computer network 1, before the email traffic is permitted to reach the computer network 1.

It is noted that more than one CBES system 20 can be included in the network security system, in which case all email traffic destined to, or received from the computer network 1 can be divided between the CBES systems.

The CBES system 20 can be owned, operated or managed by an entity that is distinct from the entity that owns, operates, manages, or uses the computer network 1. For instance, the CBES system 20 can be owned or operated by an email security provider and the computer network 1 can belong to a private organization or company.

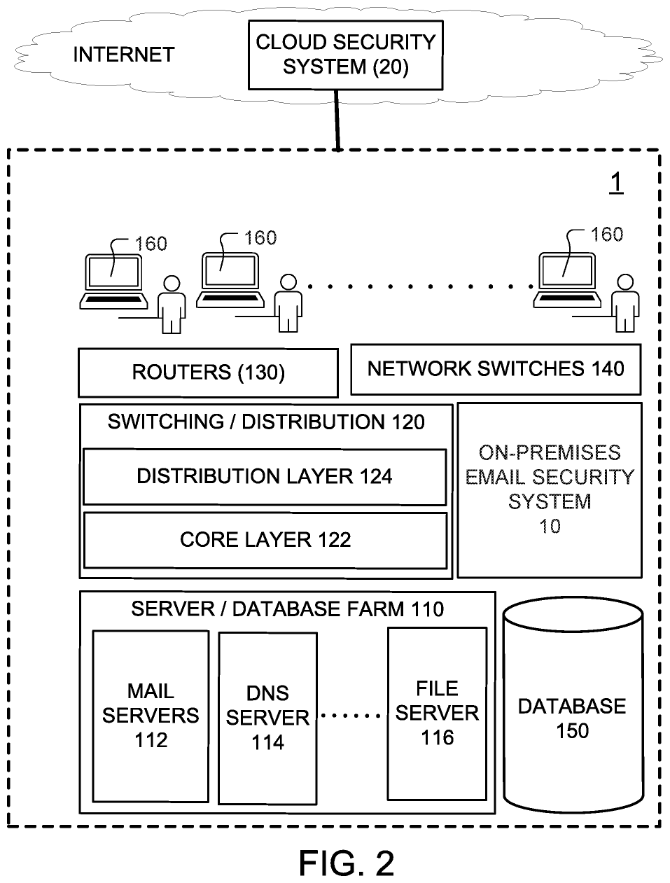

The OPES system 10 can be hosted in a demilitarized zone (DMZ) in the computer network 1. The OPES system 10 can include hardware, firmware, or software that provides security analysis, malware protection, application visibility and control, reporting, secure mobility, and protection against threats that can arise relating to email communications. The OPES system 10 can include an email transmission system comprising, for example, an email message handling system that can transfer email messages between two or more communicating devices 160 (shown in FIG. 2), or between a communicating device 160 and a communicating device (not shown) that is outside the computer network 1, in which case the email traffic could be routed through the CBES system 20.

The email message handling system can include, for example, a message transfer agent (MTA). The email message handling system can include a message delivery agent (MDA) and a message submission agent (MSA). Each of the MTA, MDA, or MSA can reside in a separate server, or within a common server in the computer network 1. The communicating device 160 can include a mail user agent (MUA) that can submit an outgoing email message to the MSA, for example, via SMTP on TCP port 25, 465, 587, or 2525, which in turn can deliver the message to the MTA. The MUA can receive an incoming email message from the MDA, after the MDA receives the message from the MTA.

In a non-limiting embodiment of the disclosure, the OPES system 10 includes an Internet-facing firewall 12, one or more email security gateways 14, and a sandbox security system 16. The OPES system 10 can include a firewall 18, or the firewall 18 can be located external to the OPES system 10, in the computer network 1 shown in FIG. 1. The firewall 18 can be located between the email security gateways 14 and sandbox security system 16 at one end and one or more backend mail servers 112 at the other end. Although shown as a separate device or module, the sandbox security system 16 can be included in the email security gateway 14. The backend mail server 112 can include, for example, a Microsoft® Exchange® server. The OPES system 10 can be configured to receive and handle all email traffic incoming into the computer network 1. The OPES system 10 can be further configured to handle all outgoing traffic from the computer network 1.

The firewall 12 can prevent unauthorized access to or from the computer network 1, while allowing email traffic to or from the CBES system 20 to pass through the firewall unimpeded. A firewall policy can be created and implemented for the firewall 12 that permits email traffic sent from the CBES system 20 to pass through the firewall 12 to the email security gateway(s) 14, and from the email security gateway(s) 14 to the CBES system 20. The OPES system 10 and CBES system 20 can use a communication protocol such as, for example, Simple Mail Transfer Protocol (SMTP) on Transmission Control Protocol (TCP), which can use a TCP port such as, for example, SMTP TCP 25, 465, 587, 2525. Thus, any email traffic that is received from a source other than the CBES system 20 can be blocked by the firewall 12 and prevented from reaching the email security gateway 14. The firewall 12 can permit all outgoing email traffic destined to the CBES system 20 to pass through unimpeded.

The email security gateway(s) 14 can be configured to facilitate secure communication between the CBES system 20 and OPES system 10 using a protocol such as, for example, Transport Layer Security (TLS) for authentication, privacy and data integrity. A digital certificate can be added in the email security gateway(s) 14 for the CBES system 20. The digital certificate can include a server name, a trusted certificate authority that vouches for the authenticity of the certificate, and the server's public encryption key.

The email security gateway 14 can analyze and filter the email traffic received from the firewall 12 to remove or remediate harmful or unwanted emails or email attachments. The email security gateway 14 can analyze all outgoing email traffic before it reaches the firewall 12, to detect and prevent any data breaches, exfiltration, or unwanted destruction of sensitive data using a Data Loss Prevention (DLP) solution (also known as Data Leakage Prevention). Alternatively (or additionally), a standalone DLP solution can be included to analyze the email traffic. The DLP solution can analyze outgoing email traffic before it reaches the firewall 18, or before it reaches the email security gateway 14, depending on the DLP solution location. All attachments in incoming email traffic can be forwarded by the email security gateway 14 to the sandbox security system 16, which can apply one or more sandboxing solutions, such as, for example, advanced malware analysis or remediation, to identify risks. The sandbox security system 16 can include a remediation process to resolve identified risks in email attachments. The sandbox security system 16 can be bypassed for all outgoing email traffic (including outgoing email attachments), where sandboxing might not provide any value for outgoing email traffic, thereby providing faster response times and lower computing resource costs.

The email security gateway 14 can include a reputation filter, message filter, anti-spam engine, anti-virus engine, content filter, or outbreak filter. The email security gateway 14 can work together with the sandbox security system 16 to scan, analyze, filter or remediate the received email traffic (including all attachments) to remove spam, spoofed emails, phishing emails, advanced persistent threat (APT) events, or other malicious emails, as well as viruses, worms, trojans and other harmful malware or hyperlinks that might exist in the incoming email traffic. The email security gateway 14 can perform the same operations for outgoing email traffic, except the sandbox security system 16 can be bypassed entirely. The email security gateway 14 can perform analysis based on, for example, packet header data, URL data, message content, payload data, and reputation data in the received email traffic. The email security gateway 14 can perform substantially the same (or different) analysis, filtering or remediation as the CBES system 20.

After the sandbox analysis has been completed, cleared emails can be forwarded to the backend mail server(s) 112 in the computer network 10. For additional security, the firewall 18 can be provided between the email security gateway(s) 14 and sandbox security system 16 and the backend mail server(s) 112, as noted earlier. The mail server(s) 112 can include, for example, SMTP servers.

Since the OPES system 10 is hosted in a DMZ (behind firewalls), only specific IP addresses and specific port numbers will be allowed to communicate with the backend mail server 112 hosted in the computer network 1. The OPES system 10 enables the computer network 1 to modify analysis or filtering parameters separately from the CBES system 20, thereby allowing the organization to customize and maintain complete control of analysis and filtering methodologies used for incoming/outgoing email traffic, separate from the CBES system 20. This provides computer networks with an ability to configure one or more external CBES systems for added layers of protection. This architecture can ensure that the most up-to-date network security solutions are being implemented, while allowing for email security solutions that can be tailored to any unique needs of the computer network 1.

In disclosed network security system, any misconfiguration on one email security gateway will be protected by the second email security gateway, thus the computer network 1 won't be affected by the misconfiguration. In addition, a compromise in the CBES email security gateway 25 or the OPES email security gateway 14 will not affect the computer network 1 as the computer network 1 has multiple layers of protection.

According to a non-limiting embodiment of the network security solution, the network security system can include a pair of CBES systems, each of which can have different email security gateways that perform different scans and analysis.

FIG. 2 shows the implementation of the OPES system 10 in a more detailed example of the computer network 1. In this non-limiting example, the computer network 1 comprises an enterprise network system that includes (in addition to the OPES system 10) a server farm 110, switching and distribution layers 120, one or more routers 130, one or more network switches 140, a database 150, and a plurality communicating devices 160, all of which can be interconnected by communication links and located behind one or more firewalls to protect against threats or breach attempts made against the computer network 1. As noted above, the computer network 1 can include a DMZ and the OPES system 10 can be located in the DMZ.

The server farm 110 can include a plurality of servers, including the backend mail server 112, a domain name system (DNS) server 114, and a file server 118. The backend mail server 112 can include a plurality of servers (not shown), including, for example, a message transfer agent (MTA) server (not shown), a mail submission agent (MSA) server (not shown), or a mail delivery agent (MDA) server (not show). The communicating devices 160 can include mail user agents (MUAs) that can interact with the MDA or MSA servers, depending on whether an email message is incoming to or outgoing from the communicating device 160.

The DNS server 114 can include a database (not shown) of all communicating devices 160 in the computer network 1 and their Internet Protocol (IP) addresses. Alternatively, the DNS server 114 can interact with the database 150, which can include a table of all computing resources and IP addresses in the computer network 1, including all communicating devices 160. The DNS server 114 can include the IP addresses for all computing resources in the CBES system 20 (shown in FIG. 1) from which email traffic can be accepted by the OPES system 10, or to which email traffic can be sent from the OPES system 10, all of which are referred to as “intermediary source IP addresses.” For instance, the DNS server 114 can include the intermediary source IP address(es) for the email security gateway(s) 25 (shown in FIG. 1).

The file server 116 (shown in FIG. 2) can include files that might be useful or necessary to the OPES system 10, including, for example, policy and profile files for the firewall 12, email security gateway 14, or sandbox security system 16 (shown in FIG. 1). The file server 116 can include other types of files, such as, for example, the most-current antivirus, antispam, antimalware, libraries or other files necessary or useful for effective email security analysis and filtering by the OPES system 10. The policy file can include a plurality of policy parameters that define how the firewall 12 will handle all incoming or outgoing email traffic, including the types of email communications that will be rejected by the firewall 12. The policy can include an IP address parameter that defines one or more IP addresses from which email traffic will be permitted to pass through the firewall 12 unimpeded.

The switching and distribution layers 120 can include a core layer 122 and a distribution layer 124. The core layer 122 can include one or more layers of switching devices (not shown) that connect the server farm 110 to the distribution layer 124. The distribution layer 124 can include one or more layers of switching devices (not shown) that connect the core layer 122 to the one or more routers 130, the one or more network switches 140, the database 150, or the OPES system 10. The switching and distribution layers 120 can include one or more routers (not shown).

The router(s) 130 can be connected to a local area network (LAN) (not shown) in the computer network 1. The router(s) 130 can include a firewall (not shown). The network switch(es) 140 can be connected to one or more communicating devices 160 by one or more associated communication links. The network switch(es) 140 can include ethernet switches. Data packets can be securely transported between communicating devices in the computer network 1.

The computer network 1 can be connected to the CBES system 20 over one or more communication links. The computer network 1, including the computing resources (for example, communicating devices 160) that are connected to the computer network 1, can operate at any one or more of the seven layers in the Open Systems Interconnection (OSI) model at any instant in time, including the application layer 1L, presentation layer 2L, session layer 3L, transport layer 4L, network layer 5L, link layer 6L, and physical layer 7L.

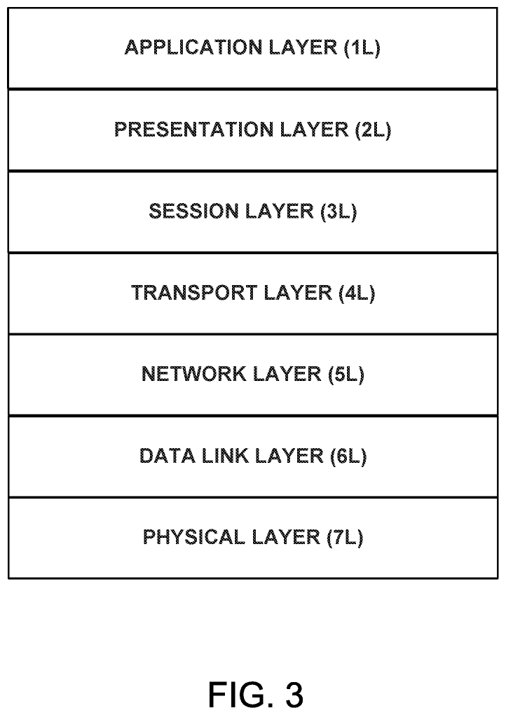

FIG. 3 shows the seven-layer OSI model. The application layer 1L is the OSI layer in a computing resource (for example, communicating device 160) that is closest to the user. The application layer 1L interacts with software applications in the communicating device that implement a communicating component. The application layer 1L can include an email application interface, such as, for example, MICROSOFT® OUTLOOK® or any enterprise email interface that an end user can interact with to, for example, receive, open, read, create, or send an email to a communicating device 160 in the computer network 1 or a communicating device (not shown) external to the computer network 1.

The presentation layer 2L establishes context between software applications, which might use different syntax and semantics. The presentation layer 2L transforms data into a form that each software application can accept. An operating system is an example of the presentation layer 2L.

The session layer 3L controls the communication connections between computing resources in the computer network 1 or between a computing resource in the network and computing resources external to the computer network 1. This layer is responsible for establishing, managing and terminating connections between local and remote applications. The layer can provide for full-duplex, half-duplex, or simplex operations, and is responsible for establishing checkpointing, adjournment, termination, and restart procedures.

The transport layer 4L provides the functional and procedural mechanisms for transferring variable-length data sequences from a source computing device to a destination computing device, while maintaining quality-of-service (QoS). The transport layer 4L controls the reliability of a given link through flow control, segmentation and desegmentation, and error control. The transport layer 4L can include, for example, tunneling protocols, the Transmission Control Protocol (TCP) and the User Datagram Protocol (UDP).

The network layer 5L provides the functional and procedural mechanisms for transferring data packets from a computing resource in a network (for example, a LAN) to another computing resource on a different network (for example, a different LAN). If the data to be transmitted is too large, the network layer 5L can facilitate splitting the data into a plurality of segments at the node and sending the fragments independently to the other node, where the segments can be reassembled to recreate the transmitted data. The network layer 5L can include one or more layer-management protocols such as, for example, routing protocols, multicast group management, network layer information and error, and network layer address assignment.

The link layer 6L is responsible for node-to-node transfer between computing devices in a communication system. In IEEE 802 implementations, the link layer 6L is divided into two sublayers, consisting of a medium access control (MAC) layer and a logical link control (LLC) layer. The MAC layer is responsible for controlling how devices in a network gain access to a medium and permission to transmit data. The LLC layer is responsible for identifying and encapsulating network layer protocols, and for controlling error checking and frame synchronization.

The physical layer 7L includes the hardware that connects the communicating devices in the computer network 1. The hardware can include for example connectors, cables, switches, and the like, that provide for transmission and reception of instruction and data streams between the communicating devices.

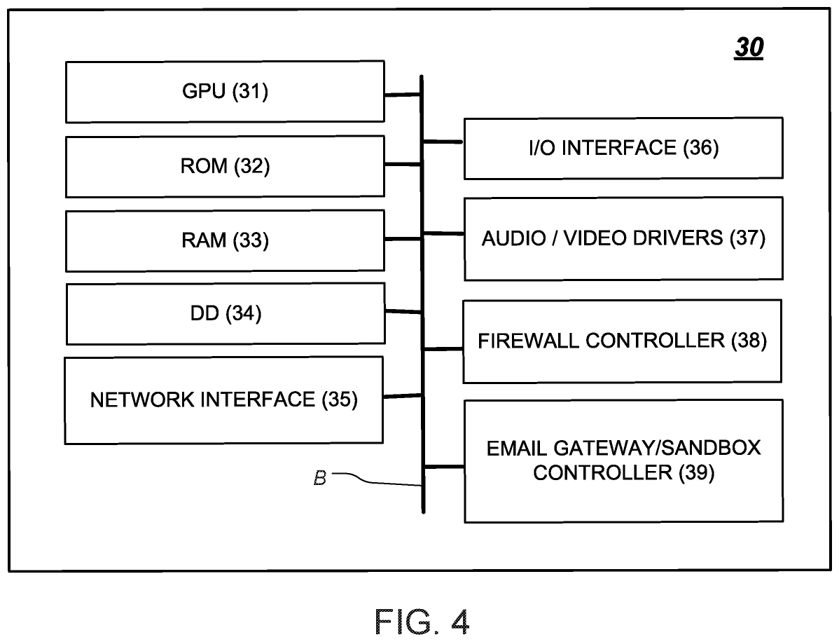

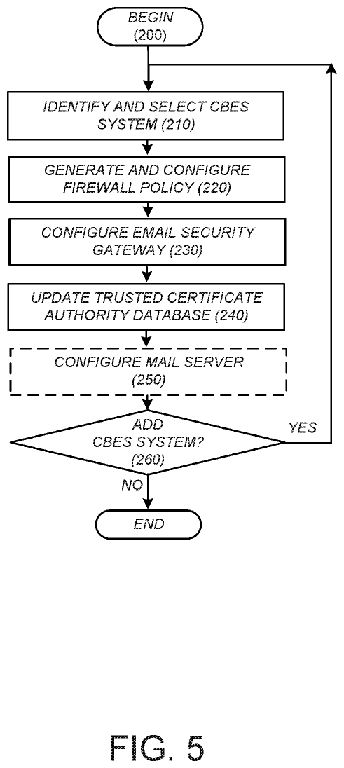

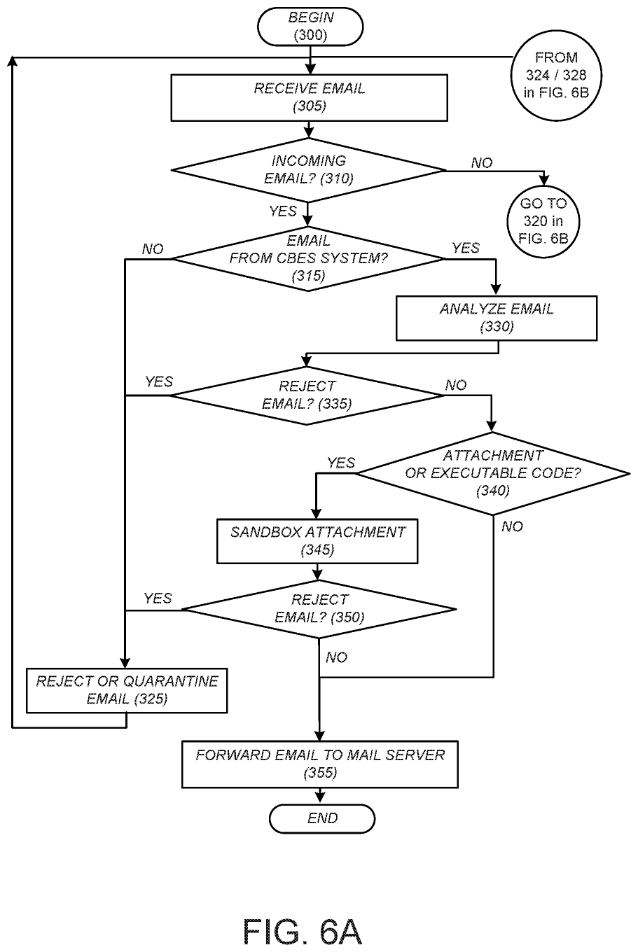

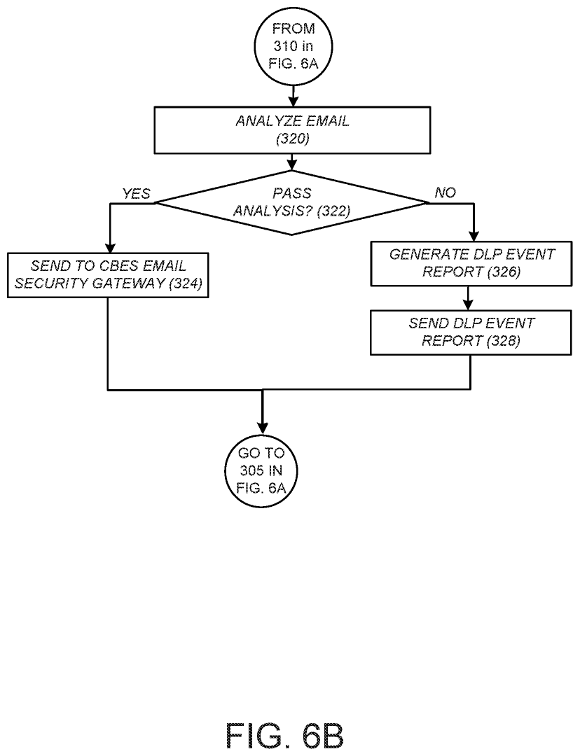

FIG. 4 shows an architecture of a non-limiting embodiment of an on-premises email security (OPES) controller 30 that can be included in the OPES system 10 (shown in FIG. 1 or FIG. 2). The OPES controller 30 can communicate with the firewall 12, email security gateway(s) 14, and sandbox security system 16 (shown in FIG. 1). The OPES controller 30 can generate and transmit instruction (or command) signals and data signals to the firewall 12, email security gateway(s) 14, or sandbox security system 16 to carry out a configuration process 200 (shown in FIG. 5) or an on-premises email security (OPES) process 300 (shown in FIGS. 6A and 6B). The OPES controller 30 can include a computing device or it can be included in a computing device as one or more modules.

Referring to FIG. 4, the OPES controller 30 can include a graphic processor unit (GPU) 31, a read-only memory (ROM) 32, a random-access memory (RAM) 33, a disk drive (DD) 34, a network interface 35, an input-output (I/O) interface 36, audio and video drivers 37, a firewall controller 38, and an email gateway and sandbox controller 39, each of which can be connected to a backbone B. The components in the OPES controller 30 can be connected to the backbone B via one or more communication links. The OPES controller 30 can be included in one or more servers (not shown), such as, for example, the email security gateway 14 (shown in FIG. 1), the server farm 110 (shown in FIG. 2), or one or more computing resources located at one or more nodes in the demilitarized zone (DMZ) in the computer network 1.

The GPU 31 can be any of various commercially available processors. Dual microprocessors and other multi-processor architectures can be employed as the GPU 31. The GPU 31 can be a central processing unit (CPU).

The OPES controller 30 includes a computer-readable medium that can hold executable or interpretable computer code (or instructions) that, when executed by the GPU 31, or firewall controller 38, or email gateway/sandbox controller 39, cause the steps, processes and methods described in this disclosure to be carried out, including the processes 200 (shown in FIG. 5) and 300 (shown in FIGS. 6A and 6B). The computer-readable medium can be provided in the ROM 32, RAM 33, DD 34, or an external computer-readable medium connected to the OPES controller 30 via the network interface 35 or the I/O interface 36. The computer readable medium can include sections of computer code that, when executed by the GPU 31, firewall controller 38, or email gateway/sandbox controller 39, cause the configuration process 200 (shown in FIG. 5) or the OPES process 300 (shown in FIGS. 6A and 6B) to be carried out, and all other process steps described or contemplated in the specification.

A basic input/output system (BIOS) can be stored in a non-volatile memory in the OPES controller 30, such as, for example, the ROM 32. The ROM 32 can include a ROM, an erasable programmable read-only memory (EPROM), or an electrically erasable programmable read-only memory (EEPROM). The BIOS can contain the basic routines that help to transfer information between computing resources within the OPES controller 30, such as during start-up. The RAM 33 can include a high-speed RAM such as static RAM for caching data, a parallel random-access machine, or any random-access storage.

The disk drive (DD) 34 can include a hard drive, such as, for example, an enhanced integrated drive electronics (EIDE) drive, a serial advanced technology attachments (SATA) drive, or any other high capacity fast hard drive that might be available and that is suitable for application in the instant disclosure. The DD 34 can include an optical disk drive that can read/write from/to a compact disk read-only memory (CD-ROM) disk (not shown), or, read from or write to other high capacity optical media such as a digital video disk (DVD). The DD 34 can be configured for external use in a suitable chassis (not shown). The DD 34 can be connected to the backbone B by a hard disk drive interface (not shown) and an optical drive interface (not shown), respectively. The hard disk drive interface (not shown) can include a Universal Serial Bus (USB) (not shown) or an IEEE 1394 interface (not shown) for external applications.

The DD 34 and associated computer-readable media can provide nonvolatile storage of data, data structures, or computer-executable instructions. The DD 34 can accommodate the storage of any data in a suitable digital format. The DD 34 can include one or more apps that are used to execute aspects of the architecture described in this disclosure.

A variety of program modules can be stored in the DD 34, ROM 32, or RAM 33, including an operating system (not shown), one or more application programs (not shown), application program interfaces (APIs) (not shown), program modules (not shown), or program data (not shown). Any (or all) of the operating system, application programs, APIs, program modules, or program data can be cached in the RAM 33 as executable sections of computer code.

The network interface 35 can be connected to the computer network 1 (shown in FIG. 1) or one or more external networks (for example, CBES system 20, shown in FIG. 1). The network interface 35 can include a wired or a wireless communication network interface (not shown) or a modem (not shown). When communicating in a local area network (LAN), the OPES controller 30 can be connected to the LAN network through the wired or wireless communication network interface; and, when communicating in a wide area network (WAN), the OPES controller 30 can be connected to the WAN network through the modem. The modem (not shown) can be internal or external and wired or wireless. The modem can be connected to the backbone B via, for example, a serial port interface (not shown).

The I/O interface 36 can receive commands and data from, for example, an operator via a user interface device (not shown), such as, for example, a keyboard (not shown), a mouse (not shown), a pointer (not shown), a microphone (not shown), a speaker (not shown), or a display (not shown). The received commands and data can be forwarded to the GPU 31, firewall controller 38, or email gateway/sandbox controller 39, from the I/O interface 27 as instruction and data signals via the backbone B.

The audio and video drivers 37 can include a graphics driver (not shown), a video adaptor (not shown), a video card (not shown), a sound card (not shown), or any other device necessary to render an image signal on a display device or an audio signal on a sound reproduction device (for example, speaker).

The network interface 35 can include a data parser (not shown) or the data parsing operation can be carried out by the GPU 31. Received data can be transferred from the network interface 35 to the GPU 31, the firewall controller 38 or the email gateway/sandbox controller 39. The network interface 35 can facilitate communication between the firewall controller 38 or email gateway/sandbox controller 39 and computing resources located internal to the computer network 1, or external to the computer network 1, such as, for example, the CBES system 20 (shown in FIG. 1). The network interface 35 can handle a variety of communication or data packet formats or protocols, including conversion from one or more communication or data packet formats or protocols used by data sources to the communication or data packet formats or protocols used in the OPES controller 30.

The firewall controller 38 can include a computing device or it can be included in a computing device as a module. The firewall controller 38 can build a firewall policy and configure a firewall (for example, firewall 12) according to the associated firewall policy. The firewall policy can include one or more policy parameters that define how the firewall will handle various types of ingoing or outgoing email traffic. For instance, the firewall policy can include a permissible IP address policy parameter that defines the particular IP addresses from which incoming email traffic will be accepted, and the particular IP addresses to which outgoing email traffic can be sent. The firewall policy can include a permissible port number parameter that defines the particular port numbers (for example, SMTP TCP port 25) in incoming email traffic that will be accepted, and the particular port numbers in outgoing email traffic that will be permitted to pass through. The firewall controller 38 can communicate with the firewall to monitor and, as necessary, interact with the firewall to make any necessary configuration changes, such as, for example, changes in intermediary source IP addresses or port numbers that can be permitted through the firewall.

The email gateway/sandbox controller 39 can include a computing device or it can be included in a computing device as a module. The email gateway/sandbox controller 39 can build an email gateway policy and configure an email security gateway (for example, email security gateway 14) according to the policy. The email gateway policy can include one or more policy parameters. For instance, the policy parameter can define the types of filters to apply to incoming or outgoing email traffic, a list of filters that can be applied, types of malware protection applications to apply, list of malware protection applications, whitelisted IP address, blacklisted IP addresses, whitelisted recipients, blacklisted recipients, list of acceptable port numbers for incoming or outgoing email traffic. The policy parameter can include an attachment parameter that indicates what types of email attachments should be forwarded to the sandbox security system 16 for analysis or remediation. The policy parameter can include a code parameter that indicates what types of executable code (for example, executable code in the mail message payload) should be forwarded to the sandbox security system 16 for analysis or remediation.

The email gateway/sandbox controller 39 can build a sandbox policy and configure a sandbox security system (for example, sandbox security system 16) according to the policy. The sandbox policy can include one or more policy parameters. For instance, the sandbox policy parameter can define the types of sandbox analysis to perform on the executable code or attachment, or the advanced malware protection to apply to the executable code or attachment.

The email gateway/sandbox controller 39 can gather data across multiple systems, including systems that might be outside the computer network 1, correlate the data and update email security policies to provide current, up-to-date cyberthreat analysis, detection and remediation processes. An email security policy can include a firewall policy, an email gateway policy or a sandbox policy. It is noted that the CBES system 20 can include email security policies that are the same as, or different than the email security policies in the OPES system 10.

FIG. 5 shows an embodiment of a configuration process 200, according to the principles of the disclosure. Referring to FIGS. 1, 4 and 5 concurrently, the CBES system 20 of a cloud email gateway service provider can be identified and selected (Step 210). The CBES system 20 should be compatible with the OPES system 10, which can be hosted in the demilitarized zone (DMZ) in the computer network 1. The CBES system 20 can read emails received from the OPES system 10, and the OPES system 10 can read emails received from the CBES system 20.

The firewall controller 38 (shown in FIG. 4) can build a firewall policy for the Internet facing firewall 12 (shown in FIG. 1) and configure the firewall 12 based on the generated policy (Step 220). The firewall controller 38 can build (or configure the firewall 12 with) the firewall policy to permit all email traffic that is received from the email security gateway 25 or CBES system 20 to pass through the firewall 12 unimpeded to the email security gateway 14 in the OPES system 10. The firewall controller 38 can further build the firewall policy and configure the firewall 12 to send all outgoing email traffic from the email security gateway 14 to the email security gateway 25 or CBES system 20, which could then transmit the email messages to destination nodes outside of the computer network 1. The firewall policy can include a policy parameter that identifies specific applications/protocols used by the email security gateway 25, and a policy parameter that identifies applications/protocols used by the email security gateway 14, such as, for example, SMTP TCP 25, 465, 587, or 2525.

The email gateway/sandbox controller 39 (shown in FIG. 4) can build an email gateway policy for the email security gateway 14 and configure the email security gateway 14 based on the policy (Step 230). The email gateway/sandbox controller 39 can configure the email security gateway 14 to use Transport Layer Security (TLS) and add a digital certificate for the email security gateway 25 or the CBES 20 (shown in FIG. 1) (Step 240). The digital certificate can be added to a certificate authority table of trusted certificates.

The email gateway policy can include a variety of parameters for handling network-incoming and network-outgoing email traffic by the email security gateway 14. For instance, the email gateway policy can include one or more policy parameters that define the security analyses and filtering to be carried out by the email security gateway 14 on incoming or outgoing email traffic, such as, for example, advanced email filtering, reputation filtering, message filtering, spam filtering, virus filtering, content filtering, outbreak filtering, malware analysis, or advanced malware protection. The email gateway policy parameters for incoming email traffic can differ from the email gateway policy parameters for outgoing email traffic. For example, the email gateway policy can include policy parameters that only incoming email attachments be forwarded to the sandbox security system 16 for analysis and that outgoing email attachments be forwarded from the backend mail server 112 to the email security gateway 14 unimpeded. The email gateway policy can include a policy parameter for outgoing email traffic that indicates all (or certain types of) outgoing email messages (including attachments) undergo DLP analysis in the email security gateway 14 or via a standalone DLP solution (not shown) to detect and prevent any data breaches, exfiltration, unwanted destruction of sensitive data, whitelist/blacklist of files and destination nodes.

Optionally, the email gateway/sandbox controller 39 can configure the backend mail server 112 to only receive emails that have been cleared through the OPES system 10 (shown in FIG. 1). For instance, the mail server 112 can be configured to accept only email communications from a node having a predefined IP address such as, for example, the IP address for the email security gateway 14.

After configuration of the OPES system 10 is completed for the CBES system 20, a determination can be made whether an additional CBES system is to be added (Step 260). If a determination is made that an additional CBES system is to be added (YES at Step 260), then the process 200 can repeat, beginning with identifying and selecting the additional CBES system (Step 210), otherwise the process can end (NO at Step 260).

An email can include a destination email address in a header portion of the email. The OPES 10 can forward the email to a next hop that includes the CBES 20. When an external user sends an email destined for a node in the computer network 1, a public domain name server (DNS) can always point to the CBES 20, and the CBES 20 can forward any email destined to the node to the OPES 10, which can look in the header and forward the email to the correct node.

FIGS. 6A and 6B show an embodiment of an OPES process 300, according to the principles of the disclosure. After the OPES system 10 and CBES system 20 (shown in FIG. 1) have been configured so that the CBES system 20 receives, analyzes, filters and remediates all email traffic destined for the computer network 1, an email message cleared by the CBES system 20 can be received by the email security gateway 14 from the email security gateway 25 (shown in FIG. 1) (Step 305). Alternatively, an outgoing email message can be received by the email security gateway 25 from the backend mail server 112 (shown in FIG. 1) (Step 305). The incoming email message can be received from an external source node (not shown)—that is, other than any node in the CBES system 20 or in the computer network 1 (Step 305).

If the received email message is an outgoing email message received from the mail server 112 (shown in FIG. 1) (NO at Step 310), then the email message can be analyzed and filtered by the email security gateway 14 according to the policy for outgoing email traffic (Step 320, FIG. 6B), otherwise (YES at Step 310) a determination can be made whether the email message was received from an authorized node in the CBES system 20 (Step 315). If the email message was received an authorized node in the CBES system 20, such as, for example, the email security gateway 25 (YES at Step 330), then the email message can be analyzed and filtered by the email security gateway 14 according to the policy for incoming email traffic (Step 330), otherwise the email message can be rejected (YES at Step 315, then Step 325). The determination in Step 315 can be made in either the firewall 12 (shown in FIG. 1) or the email security gateway 14 by, for example, comparing the sender IP address in the email message data packet headers to the list of authorized IP addresses stored in, for example, the DNS server 114 (shown in FIG. 2) or locally in the OPES controller 30 (shown in FIG. 4), including intermediary source IP addresses. The email message can be rejected by the email security gateway 14 or by the Internet facing firewall 12, thereby preventing the email message from ever reaching the email security gateway 14.

After the email message is analyzed (Step 330), a determination can be made whether to reject the email message based on the analysis results (Step 335). If the email message is found to be malicious, unwanted or otherwise rejectable based on the applicable policy parameters, such as, for example, where the email message is spam, a phishing email, or from a blocked IP address (YES at Step 335), then the email message is rejected (Step 325), otherwise a determination can be made whether the email message includes executable code or an attachment (Step 340). It is noted that Step 340 can be carried out simultaneously with Step 330 and the determination of whether to reject the email (Step 335) can be carried out at the conclusion of both (or either) Step 330 and Step 340.

If the email message is determined to include executable code or an attachment (YES at Step 340), then the executable code or attachment can be sent to the sandbox security system 16 (shown in FIG. 1) to carryout, for example, advanced malware analysis or remediation (Step 345); otherwise, the email message can be forwarded to the backend mail server 112 to be delivered to a destination node (for example, a communicating device 160, shown in FIG. 2). A determination can be made by, for example, the sandbox security system 16, whether the executable code or attachment includes any malware or other component that could present a risk to any part of the computer network 1 (Step 350). If the executable code or attachment presents any risk (YES at Step 350), then the executable code or attachment can be rejected or quarantined (Step 325), otherwise (NO at Step 350) the email message is forwarded to the backend server 112 to be delivered to the destination node (Step 355). In Step 350, it is noted that the executable code or attachment can be removed from the email message and the cleaned email message forwarded to the backend mail server 112 (Step 355), without the executable code or attachment.

Referring to FIG. 6B, after the received email message (Step 305, FIG. 6A) is determined to be an outgoing email message that originated in the computer network 1 and is destined to an IP address that is outside the computer network 1 (Step 310, FIG. 6A), the email message can be analyzed and filtered by the email security gateway 14 according to the policy for outgoing email traffic (Step 320). If it is determined, based on the results of the analysis, that the email message includes evidence of a data breach, exfiltration, unwanted destruction of sensitive data, a whitelisted or blacklisted file, a whitelisted or blacklisted IP address or domain (for example, an IP address in the email message), or any other indication of a risky event (NO at Step 322), then the event can be logged and a data loss prevention (DLP) report generated (Step 326). The DLP report can include a copy of the email with any attachments, the analysis performed on the email, and the results of the analysis. The DLP report can be sent to a predetermined node in the computer network 1 (shown in FIG. 1), such as, for example, a communicating device 160 at a security analyst location (Step 328).

If it is determined however, based on the results of the analysis (Step 320), that the email message satisfies all policy requirements for outgoing email traffic (YES at Step 322), then the email message can be sent to the email security gateway 15 in the CBES 20 (shown in FIG. 1) to be forwarded by the CBES 20 to one or more destination nodes (not shown) indicated in the email message (Step 324).

The OPES controller 30 (shown in FIG. 4) can log every email rejection event (Step 325) carried out by the firewall 12 and email security gateway 14 and store the log data locally or in the database 150 (shown in FIG. 2). The log data can be later analyzed and used to modify or update filter/analysis policy data for the firewall controller 38 and email gateway/sandbox controller 39 (shown in FIG. 4).

The terms “a,” “an,” and “the,” as used in this disclosure, means “one or more,” unless expressly specified otherwise.

The term “backbone,” as used in this disclosure, means a transmission medium that interconnects one or more computing resources to provide a path that conveys data signals and instruction signals between the one or more computing resources. The backbone can include a bus or a network. The backbone can include an ethernet TCP/IP. The backbone can include a distributed backbone, a collapsed backbone, a parallel backbone or a serial backbone. The backbone can include any of several types of bus structures that can further interconnect to a memory bus (with or without a memory controller), a peripheral bus, and a local bus using any of a variety of commercially available bus architectures.

The term “communicating device,” as used in this disclosure, means any hardware, firmware, or software that can transmit or receive data packets, instruction signals, data signals or radio frequency signals over a communication link. The communicating device can include a computer or a server. The communicating device can be portable or stationary.

The term “communication link,” as used in this disclosure, means a wired or wireless medium that conveys data or information between at least two points. The wired or wireless medium can include, for example, a metallic conductor link, a radio frequency (RF) communication link, an Infrared (IR) communication link, or an optical communication link. The RF communication link can include, for example, WiFi, WiMAX, IEEE 802.11, DECT, 0G, 1G, 2G, 3G, 4G, or 5G cellular standards, or Bluetooth. A communication link can include, for example, an RS-232, RS-422, RS-485, or any other suitable serial interface.

The terms “computer” or “computing device,” as used in this disclosure, means any machine, device, circuit, component, or module, or any system of machines, devices, circuits, components, or modules which are capable of manipulating data according to one or more instructions, such as, for example, without limitation, a processor, a microprocessor, a graphics processing unit, a central processing unit, a general purpose computer, a super computer, a personal computer, a laptop computer, a palmtop computer, a notebook computer, a desktop computer, a workstation computer, a server, a server farm, a computer cloud, or an array of processors, microprocessors, central processing units, general purpose computers, super computers, personal computers, laptop computers, palmtop computers, notebook computers, desktop computers, workstation computers, or servers.

A “computing resource,” as used in this disclosure, means any computing device, communicating device, computer program, computer application, application program interface, or any other software, firmware, or hardware that can receive, transmit or process an instruction or command or data.

The term “computer-readable medium,” as used in this disclosure, means any storage medium that participates in providing data (for example, instructions) that can be read by a computer. Such a medium can take many forms, including non-volatile media and volatile media. Non-volatile media can include, for example, optical or magnetic disks and other persistent memory. Volatile media can include dynamic random access memory (DRAM). Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave, or any other medium from which a computer can read. The computer-readable medium can include a “Cloud,” which includes a distribution of files across multiple (for example, thousands of) memory caches on multiple (for example, thousands of) computers.

Various forms of computer readable media can be involved in carrying sequences of instructions to a computer. For example, sequences of instruction (i) can be delivered from a RAM to a processor, (ii) can be carried over a wireless transmission medium, or (iii) can be formatted according to numerous formats, standards or protocols, including, for example, WiFi, WiMAX, IEEE 802.11, DECT, 0G, 1G, 2G, 3G, 4G, or 5G cellular standards, or Bluetooth.

The term “database,” as used in this disclosure, means any combination of software or hardware, including at least one application or at least one computer. The database can include a structured collection of records or data organized according to a database model, such as, for example, but not limited to at least one of a relational model, a hierarchical model, or a network model. The database can include a database management system application (DBMS) as is known in the art. The at least one application may include, but is not limited to, for example, an application program that can accept connections to service requests from clients by sending back responses to the clients. The database can be configured to run the at least one application, often under heavy workloads, unattended, for extended periods of time with minimal human direction.

The terms “including,” “comprising” and their variations, as used in this disclosure, mean “including, but not limited to,” unless expressly specified otherwise.

The term “network” or “subnetwork,” as used in this disclosure means, but is not limited to, for example, at least one of a local area network (LAN), a wide area network (WAN), a metropolitan area network (MAN), a personal area network (PAN), a campus area network, a corporate area network, a global area network (GAN), a broadband area network (BAN), a cellular network, or the Internet, any of which can be configured to communicate data via a wireless or a wired communication medium. These networks can run a variety of protocols not limited to TCP/IP, IRC or HTTP.

The term “node,” as used in this disclosure, means a physical or virtual location in a computer network that comprises a computing resource.

The term “server,” as used in this disclosure, means any combination of software or hardware, including at least one application or at least one computer to perform services for connected clients as part of a client-server architecture, server-server architecture or client-client architecture. A server can include a mainframe or a server cloud or server farm. The at least one server application can include, but is not limited to, for example, an application program that can accept connections to service requests from clients by sending back responses to the clients. The server can be configured to run the at least one application, often under heavy workloads, unattended, for extended periods of time with minimal human direction. The server can include a plurality of computers configured, with the at least one application being divided among the computers depending upon the workload. For example, under light loading, the at least one application can run on a single computer. However, under heavy loading, multiple computers can be required to run the at least one application. The server, or any if its computers, can also be used as a workstation.

The term “transmission” or “transmit,” as used in this disclosure, means the conveyance of data, data packets, computer instructions, or any other digital or analog information via electricity, acoustic waves, light waves or other electromagnetic emissions, such as those generated with communications in the radio frequency (RF) or infrared (IR) spectra. Transmission media for such transmissions can include coaxial cables, copper wire and fiber optics, including the wires that comprise a system bus coupled to the processor.

Devices that are in communication with each other need not be in continuous communication with each other unless expressly specified otherwise. In addition, devices that are in communication with each other may communicate directly or indirectly through one or more intermediaries.

Although process steps, method steps, or algorithms may be described in a sequential or a parallel order, such processes, methods and algorithms may be configured to work in alternate orders. In other words, any sequence or order of steps that may be described in a sequential order does not necessarily indicate a requirement that the steps be performed in that order; some steps may be performed simultaneously. Similarly, if a sequence or order of steps is described in a parallel (or simultaneous) order, such steps can be performed in a sequential order. The steps of the processes, methods or algorithms described in this specification may be performed in any order practical. In certain non-limiting embodiments, one or more process steps, method steps, or algorithms can be omitted or skipped.

When a single device or article is described, it will be readily apparent that more than one device or article may be used in place of a single device or article. Similarly, where more than one device or article is described, it will be readily apparent that a single device or article may be used in place of the more than one device or article. The functionality or the features of a device may be alternatively embodied by one or more other devices which are not explicitly described as having such functionality or features.

While the disclosure has been described in terms of exemplary embodiments, those skilled in the art will recognize that the disclosure can be practiced with modifications in the spirit and scope of the appended claims. These examples are merely illustrative and are not meant to be an exhaustive list of all possible designs, embodiments, applications, or modifications of the disclosure.

What is claimed is:

1. A method for analyzing and filtering an email message destined to a computing resource in a computer network that has been security processed by a cloud-based email security system, the method comprising:
establishing a communication link with the cloud-based email security system that applies a cloud-based email security policy to analyze and filter all email traffic destined to the computer network;
receiving an email message by an on-premises email security (OPES) system hosted in a demilitarized zone in the computer network;
determining whether the received email message is sent from an authorized node in the cloud-based email security system;
forwarding the received email message to an on-premises email security gateway located in the demilitarized zone based on whether the email message was sent from the authorized node in the cloud-based email security system;
analyzing the forwarded email message by the on-premises email security gateway based on an on-premises email security policy; and
sending, by the on-premises email security gateway, the forwarded email message to a mail server in the computer network,
wherein the mail server receives as incoming email traffic only email messages received from the authorized node in the cloud-based email security system.

2. The method in claim 1, further comprising:
determining whether the received email message includes an authorized port number.

3. The method in claim 2, wherein the authorized port number is port 25.

4. The method in claim 1, wherein the determining the authorized node comprises:
identifying an intermediary source IP address; and
comparing the intermediary source IP address against a table of authorized IP addresses.

5. The method in claim 4, wherein the determining the authorized node further comprises:
identifying a port number in the email message; and
comparing the port number against an authorized port number.

6. The method in claim 1, wherein the cloud-based email security policy includes policy parameters that differ from policy parameters in the on-premises email security policy.

7. The method in claim 1, wherein the on-premises email security policy comprises a policy parameter that causes the on-premises email security gateway to analyze the email message using spam detection, sender reputation, email filtering, content analysis, or advanced malware protection.

8. The method in claim 1, wherein the on-premises email security policy comprises a policy parameter that causes the on-premises email security gateway to analyze an outgoing email message using data leakage prevention (DLP), a whitelist of files, a blacklist of files, a whitelist of recipients, or a blacklist of recipients.

9. The method in claim 1, wherein the email message comprises a header that includes an IP address of a node located in the computer network.

10. The method in claim 1, wherein the email message comprises a header that includes an IP address of a node located outside of the computer network and outside of the cloud-based email security system.

11. The method in claim 10, further comprising:
determining whether the received email message is sent from the mail server located in the computer network;
analyzing the email message according to the on-premises email security policy; and
forwarding the email message to a cloud-based email security gateway.

12. A network security system having a cloud-based email security system that analyzes and filters all email traffic destined to a computer network according to a cloud-based email security policy, the system comprising:
an on-premises email security gateway that
receives incoming email traffic solely from a cloud-based email security gateway located in the cloud-based email security system,
analyzes and filters the received email traffic according to an on-premises email security policy, and
forwards any email attachments;
a sandbox security system that receives the email attachments and analyzes the attachments to detect malware; and
a mail server that receives filtered email traffic from the on-premises email security gateway,
wherein the filtered email traffic consists only of email messages received from an authorized node in the cloud-based email security system.

13. The network security system in claim 12, wherein the on-premises email security gateway determines whether the incoming email traffic comprises an authorized port number.

14. The system in claim 12, the system further comprising an Internet facing firewall that filters all email traffic to the computer network, wherein the firewall is configured to allow only incoming email traffic from the authorized node to pass through to the on-premises email security gateway.

15. A non-transitory computer readable storage medium storing email security analysis and filtering program instructions for causing an email message from a cloud-based email security system that analyzes and filters all email traffic destined to a computer network according to a cloud-based email security policy to be analyzed and filtered, the program instructions comprising the steps of:
establishing a communication link with the cloud-based email security system which uses first analysis and filtering policy parameters;
receiving an email message by an on-premises email security (OPES) system hosted in a demilitarized zone in the computer network;
determining whether the received email message is sent from an authorized node in the cloud-based email security system;
forwarding the received email message to an on-premises email security gateway located in the demilitarized zone based on whether the email message was sent from the authorized node in the cloud-based email security system;
analyzing the forwarded email message by the on-premises email security gateway based on second analysis and filtering policy parameters; and
sending, by the on-premises email security gateway, the forwarded email message to a mail server in the computer network,
wherein the mail server receives as incoming email traffic only email messages received from the authorized node in the cloud-based email security system.

16. The non-transitory computer readable storage medium in claim 15, the program instructions comprising the further step of:
determining whether the received email message includes an authorized port number.

17. The non-transitory computer readable storage medium in claim 16, wherein the authorized port number is port 25.

18. The non-transitory computer readable storage medium in claim 15, the program instructions comprising the further steps of:
identifying an intermediary source IP address; and
comparing the intermediary source IP address against a table of authorized IP addresses.

19. The non-transitory computer readable storage medium in claim 18, the program instructions comprising the further steps of:
identifying a port number in the email message; and
comparing the port number against an authorized port number.

20. The non-transitory computer readable storage medium in claim 15, the program instructions comprising the further step of:
applying a policy parameter that causes the on-premises email security gateway to:
analyze the email message using spam detection, sender reputation, email filtering, content analysis, or advanced malware protection; or
analyze an outgoing email message using data leakage prevention (DLP), a whitelist of files, a blacklist of files, a whitelist of recipients, or a blacklist of recipients.
